(19) United States
(12) Patent Application Publication
(10) Pub. No.: US 2016/0087870 A1
(43) Pub. Date: Mar. 24, 2016

(54) PATH SETTING VERIFICATION DEVICE, CONTROL METHOD AND PROGRAM

(71) Applicant: NEC CORPORATION, Tokyo (JP)

(72) Inventor: Toshio TONOUCHI, Tokyo (JP)

(73) Assignee: NEC CORPORATION, Tokyo (JP)

(21) Appl. No.: 14/785,332

(22) PCT Filed: Dec. 10, 2013
(86) PCT No.: PCT/JP2013/083024

§ 371 Date: Oct. 17, 2015

(30) Foreign Application Priority Data
Apr. 26, 2013 (JP) 2013-094296

(51) Int. Cl. H04L 12/751

(52) U.S. Cl. CPC H04L 45/02

(57) ABSTRACT

A path setting verification device verifies a validity of a path setting in the network system including a host, a switch, and a control device. A topology information acquisition unit acquires information on topology. A path setting information acquisition unit acquires path setting information which is used in updating the path setting by the control device. A test header generation unit generates a test header which is given to a test packet, using the path setting information. A test data generation unit generates a packet sequence which is simulated using the test header. A switch simulation unit simulates an operation of the switch, and a control device simulation unit simulates an operation of the control device. A path setting verification unit verifies a validity of the simulated path setting.

### TECHNICAL FIELD

The present invention relates to a technique for verifying a path setting in a network system.

### BACKGROUND ART

In network systems in which information is communicated between hosts connected through a network, packets are transmitted and received between hosts. Here, the host refers to a network interface included in various computers. In addition, the packet refers to data to be transmitted and received through a network. In a network system, a switch relays packets. The switch transmits the packets from an appropriate port, discards the packets, or the like, based on information about a transmission source or a transmission destination in the received packets. The switch holds a path table, which is a set of rules indicating how to relay the received packets. The switch relays the packets in accordance with this path table. In a network system, a setting indicating how and which packets are relayed is called a path setting in the network system. The path setting is determined by a set of path tables of each switch included in the network system.

In addition, recently, a technique has been used in which an external device (hereinafter, control device) dynamically performs a path setting in accordance with a request from each switch without performing a path setting in advance. This technique is called an SDN (Software-Defined Network). For example, a path setting is performed in the following method. First, a switch having received a packet determines whether a rule for relaying the packet is set in a path table. When the rule for relaying the packet is not set in the path table, a control request for obtaining a setting or the like of the path table is transmitted to a control device. The control device having received the control request performs the setting or the like of the path table on the switch. A path setting in a network system is updated in such a flow.

In a network system, it is important to verify the validity of path settings. This is because a packet is not relayed to a correct transmission destination if the path setting is not correct, and information is not able to be delivered correctly between hosts. In addition, as described above, in a system in which a path setting is performed dynamically, a path setting is changed depending on the contents of packets flowing through a network system, on the order of packets being transmitted, or the like. For this reason, in a network system in which a path setting is performed dynamically, it is necessary to verify the validity of each of various path settings capable of being set.

For example, Non-Patent Document 1 discloses a device that verifies whether there is no error in a process performed by a control device in a network system using OpenFlow, which is an implementation of an SDN. This device simulates transitions of a state of the network system, using a method called symbolic execution. Here, the state of the network system is represented by a combination of the state of a path table that each switch has, the state of a packet queue, or the like.

### RELATED DOCUMENTS

### Non-Patent Documents

[Non-Patent Document 1] Marco Canini, and four others, “A NICE Way to Test OpenFlow Applications”, EPFL Technical Report EPFL-REPORT-169211, 2011
[Non-Patent Document 2] Peyman Kazemian, and two others, “Header Space Analysis: Static Checking For Networks”, Proceedings of the 9th USENIX conference on Networked Systems Design and Implementation (NSDI '12), 2012, pp. 9-22

### SUMMARY OF THE INVENTION

The inventor has examined a method of shortening the time spent to verify the validity of a path setting in a network system in which a path setting is performed dynamically. The device disclosed in Non-Patent Document 1 requires a lot of time in order to estimate each path setting capable of being set in a network system. For example, such a device requires thirty hours in order to simulate the five-time execution of ping in a host. One of the causes is an increase in the number of states capable of being taken by the network system due to even a state not involved with the update of a path setting is considered, such as the state of a packet queue. In addition, it is considered that a simulation using the symbolic execution, which is a method taking a long time to perform, is also one of the causes.

The present invention is contrived in view of the above problems. An object of the present invention is provide a technique for verifying in a short time the validity of a path setting in a network system in which a path setting is performed dynamically.

According to the present invention, there is provided a path setting verification device verifying a path setting of a network system including a host, a switch, and a control device. The host is connected to at least one of the switches, and transmits a packet to the connected switch. The switch is connected to the control device, and the host or the other switch, holds a path table indicating a relay rule for relaying the received packet, and performs a relay process of transmitting to the control device a control request including a header of the packet when the relay rule regarding the received packet is not included in the path table. The control device performs a control process of executing an event handler corresponding to an execution condition based on path setting information indicating the event handler and the execution condition in association with each other, when information indicated by the received control request meets the execution condition, the execution condition being a condition in which an event handler is executed. The path setting verification device comprises: a topology information acquisition unit acquiring topology information indicating a connection relationship between the host and the switch; a path setting information acquisition unit acquiring the path setting information; a virtual path table storage unit storing a virtual path table set, which is a set of virtual path tables obtained by simulating each path table held by a plurality of the switches; a test header generation unit generating a test header so that the test header satisfies the execution condition, using the execution condition including a condition relating to the header of the packet among the execution condition indicated in the path setting information; a test data generation unit generating a test packet set, which is a direct-product set between a set of the hosts and a set of the test headers, and generating test data, which is a set of all permutations capable of being generated by ranking all elements included in the test packet set; a switch simulation unit sequentially extracting the permutations from the test data, initializing all the virtual path tables when extracting each of the permutations, sequentially extracting the elements from the extracted permutations, and simulating the relay process performed by the switch connected to the host indicated by the extracted elements, the relay process being for the packet having the test header indicated by the elements; a control device simulation unit simulating the control process performed by the control device on the control request, using the path setting information, when the control request is transmitted in the simulated relay process; and a path setting verification unit verifying a validity of a path setting represented by the virtual path table set, using the topology information and the virtual path table set. In addition, the topology information further indicates a connection relationship between the switches when the switches are connected to each other. In addition, when a packet is transmitted to another switch by the simulated relay process or the control process, the switch simulation unit recursively simulates the relay process performed by the switch receiving the packet.

According to the present invention, there is provided a control method executed by a computer. The control method is a method of causing the computer to verify a path setting in a network system to be verified by the path setting verification device according to the present invention. The control method comprises: a topology information acquisition step of acquiring topology information indicating a connection relationship between the host and the switch and a connection relationship between the switches; a path setting information acquisition step of acquiring the path setting information; a test header generation step of generating a test header so that the test header satisfies the execution condition, using the execution condition including a condition relating to the header of the packet among the execution condition indicated in the path setting information; a test data generation step of generating a test packet set, which is a direct-product set between a set of the hosts and a set of the test headers, and generating test data, which is a set of all permutations capable of being generated by ranking all elements included in the test packet set; a switch simulation step of sequentially extracting the permutations from the test data, initializing all the virtual path tables when extracting each of the permutations, sequentially extracting the elements from the extracted permutations, and simulating the relay process performed by the switch connected to the host indicated by the extracted elements, the relay process being for the packet having the test header indicated by the elements; a control device simulation step of simulating the control process performed by the control device on the control request, using the path setting information, when the control request is transmitted in the simulated relay process; and a path setting verification step of verifying a validity of a path setting represented by the virtual path table set, using the topology information and the virtual path table set. In addition, the topology information further indicates a connection relationship between the switches when the switches are connected to each other. In addition, when a packet is transmitted to another switch by the simulated relay process or the control process, the switch simulation step includes a step of recursively simulating the relay process performed by the switch receiving the packet.

According to the present invention, there is provided a program causing a computer to function as the path setting verification device according to the present invention. The program causes the computer to have a function included in each functional configuration unit of the path setting verification device according to the present invention.

According to the present invention, it is possible to provide a technique for verifying in a short time the validity of a path setting in a network system in which a path setting is perform dynamically.

### BRIEF DESCRIPTION OF THE DRAWINGS

The above-mentioned objects, other objects, features and advantages will be made clearer from the preferred exemplary embodiments described below, and the following accompanying drawings.

FIG. 1 is a block diagram illustrating a path setting verification device according to Exemplary embodiment 1.

FIG. 2 is a block diagram illustrating a network system to be verified.

FIG. 3 is a diagram illustrating a configuration of a test header.

FIG. 4 is a diagram illustrating a configuration of a test packet.

FIG. 5 is a diagram illustrating a configuration of a virtual path table set.

FIG. 6 is a diagram illustrating a hardware configuration of the path setting verification device according to Exemplary embodiment 1.

FIG. 7 is a flow diagram illustrating a flow of a whole of processes executed by the path setting verification device according to Exemplary embodiment 1.

FIG. 8 is a flow diagram illustrating a flow of packet processing executed by the path setting verification device according to Exemplary embodiment 1.

FIG. 9 is a block diagram illustrating a path setting verification device according to Exemplary embodiment 2.

FIG. 10 is a block diagram illustrating a path setting verification device according to Exemplary embodiment 3.

FIG. 11 is a diagram conceptually illustrating a state transition of virtual path table sets.

FIG. 12 is a block diagram illustrating a configuration of a network system in an example.

FIG. 13 is a diagram illustrating event handlers and execution conditions indicated by path setting information in the example.

FIG. 14 is a diagram illustrating a transition of a virtual path table set in the example.

### DESCRIPTION OF EMBODIMENTS

Hereinafter, exemplary embodiments of the present invention will be described with reference to the accompanying drawings. In all the drawings, like elements are referenced by like reference numerals and the descriptions thereof will not be repeated.

### Exemplary Embodiment 1

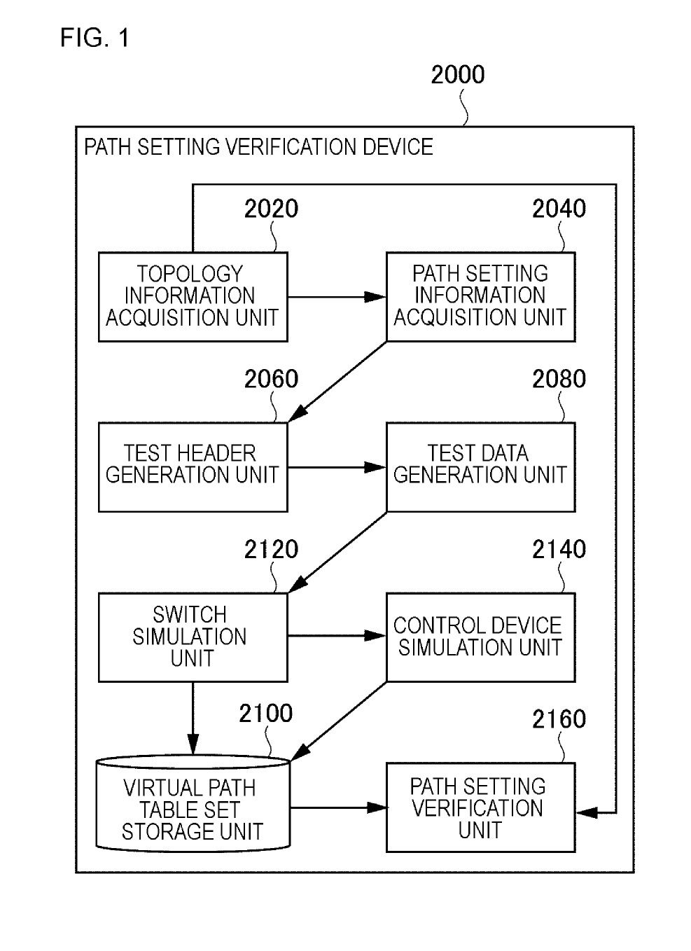

FIG. 1 is a block diagram illustrating a path setting verification device 2000 according to Exemplary embodiment 1. In FIG. 1, a flow of arrows indicates a flow of information. In addition, in FIG. 1, each block represents a function-based block rather than a hardware-based configuration.

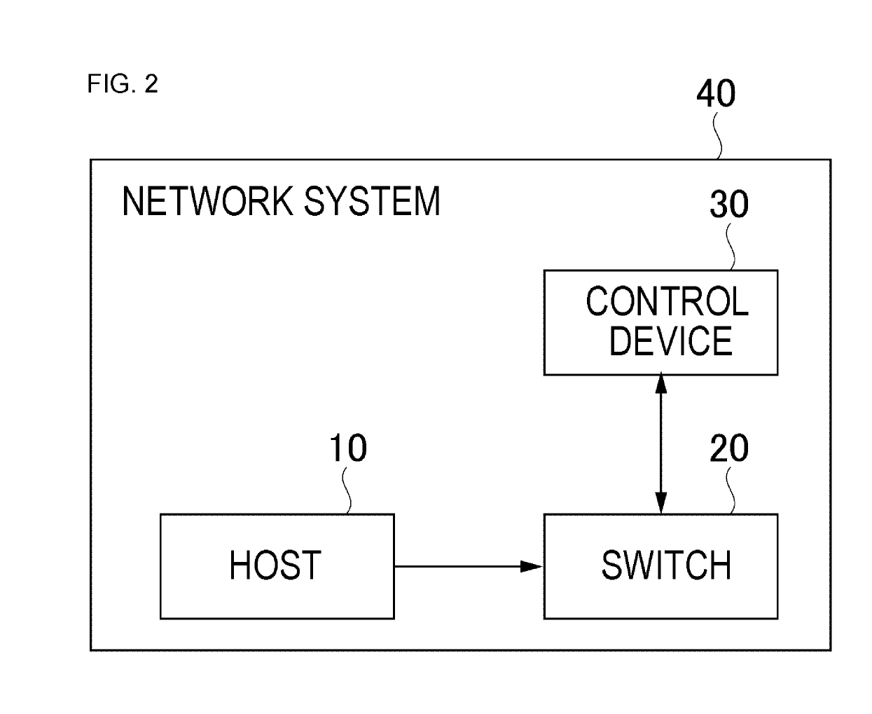

The path setting verification device 2000 verifies a path setting of a network system 40 shown in FIG. 2. The network system 40 includes a host 10, a switch 20, and a control device 30. The path setting verification device 2000 simulates an operation of the network system 40 in order to verify the path setting of the network system 40. Here, the path setting in the network system 40 is a setting indicating how each switch relays each packet. In other words, the path setting in the network system 40 indicates through which path each packet flows within the network system 40.

Hereinafter, first, the network system 40 simulated by the path setting verification device 2000 will be described.

<Host 10>

The host 10 is a network interface included in a computer such as a PC (Personal Computer) or a server. For example, the network interface is a network interface card (NIC). When one PC includes a plurality of network interfaces, the respective network interfaces are handled as hosts 10 different from each other.

The host 10 is connected to at least one switch 20. A packet is transmitted to the switch 20 connected thereto. Here, the packet is data transmitted through a network. The packet includes a header indicating various types of information. Information indicated in the header will be described later.

<Switch 20>

The switch 20 is connected to the control device 30. In addition, the switch 20 is connected to at least one host 10 or another switch 20. The switch 20 has a path table indicating a relay rule. The relay rule is a rule for relaying a received packet. For example, the relay rule is a rule indicating a relay method based on a MAC (Media Access Control) address or an IP (Internet Protocol) address indicated by the header of the received packet, a rule indicating a relay method based on an input port on which a packet is received, or the like. For example, the relay rule indicates a rule in which “when a destination MAC (Media Access Control) address indicated by the header of a received packet is XX:XX:XX:XX:XX:XX, the packet is output from a port 2”.

The switch 20 relays a received packet. When the relay rule regarding the received packet is included in a path table, the switch 20 transmits or discards the packet in accordance with the relay rule. On the other hand, when the relay rule regarding the received packet is not included in the path table, the switch 20 transmits a control request to the control device 30. The control request is for transmitting to the control device 30 information about a packet received by the switch 20 and for indicating a request for a control process thereof. For example, the control request indicates information included in the header of the packet received by the switch 20. In addition, for example, the control request indicates a port number of the port of the switch 20 that receives the packet.

<Control Device 30>

The control device 30 is a device for controlling an operation of the switch 20. The control device 30 receives a control request from the switch 20, and updates the path table that the switch 20 has in response to the received control request, or the like.

The control device 30 operates based on path setting information. The path setting information associates an event handler with an execution condition, which is a condition in which the event handler is executed. For example, the path setting information is represented by a form of a program. When a control request is received from the switch 20, the control device 30 compares information indicated by the control request with an execution condition indicated by the path setting information. When the information indicated by the control request satisfies an execution condition, the control device 30 performs a process indicated by the event handler corresponding to the execution condition.

The process performed by the event handler is, for example, an update of the path table that the switch 20 has. Specifically, the control device 30 adds the relay rule into the path table of the switch 20 by executing the event handler. Along with that the path table of the switch 20 is updated, the path setting in the network system 40 is updated. Note that, the event handler may transmit the relay rule to the switch 20 instead of updating the path table of the switch 20. In this case, the switch 20 having received the relay rule updates the path table by itself.

The path setting verification device 2000 verifies the path setting in the network system 40 having the above-mentioned feature. For this reason, the path setting verification device 2000 includes a topology information acquisition unit 2020, a path setting information acquisition unit 2040, a test header generation unit 2060, a test data generation unit 2080, a virtual path table set storage unit 2100, a switch simulation unit 2120, a control device simulation unit 2140, and a path setting verification unit 2160. Hereinafter, these functional configuration units will be described in detail.

<Topology Information Acquisition Unit 2020>

The topology information acquisition unit 2020 acquires topology information. The topology information indicates a connection relationship between the host 10 and the switch 20. The topology information indicates to which port of which switch 20 the host 10 is connected. In addition, when the switches 20 are connected to each other, the topology information also indicates a connection relationship between the switches 20. In this case, the topology information indicates which port of which switch 20 is connected to which port of another switch 20. The topology information may further indicate a MAC address or an IP address of the host 10.

<Path Setting Information Acquisition Unit 2040>

The path setting information acquisition unit 2040 acquires the path setting information. This is information having the same contents as those of the path setting information used by the control device 30 to be simulated by the path setting verification device 2000. For example, the path setting information acquisition unit 2040 acquires the path setting information from the control device 30 to be simulated. In addition, the path setting information acquisition unit 2040 may acquire the path setting information from a device other than the control device 30, and may accept a manual input of the path setting information.

<Test Header Generation Unit 2060>

The test header generation unit 2060 generates a test header using the path setting information acquired by the path setting information acquisition unit 2040. The test header includes information satisfying any of the execution conditions indicated by the path setting information. When the path setting information indicates a plurality of execution conditions, the path setting information acquisition unit 2040 generates a test header based on each of the plurality of execution conditions. The test header is information included in the header of a packet to be simulated.

Here, when there are a plurality of pieces of information satisfying one execution condition, the test header generation unit 2060 generates a test header using any of the pieces of information. For example, when the execution condition is “a transmission source IP address is 192.168.0.* (* is a wild card)” or the like, the number of transmission source IP addresses satisfying the execution condition is two or more. In this case, the test header generation unit 2060 selects an appropriate one from the IP addresses satisfying this condition and uses the address. For example, the test header generation unit 2060 randomly selects one of the pieces of information satisfying the execution condition. Besides, for example, the test header generation unit 2060 determines the information satisfying the execution condition using the topology information. Suppose that the information for satisfying the execution condition is an IP address of a transmission source host. Further, suppose that the topology information indicates the IP address of the host 10. In this case, when the IP address of the host 10 is included in a plurality of IP addresses satisfying the execution condition, the test header generation unit 2060 uses the IP address of the host 10 as information that the test header indicates.

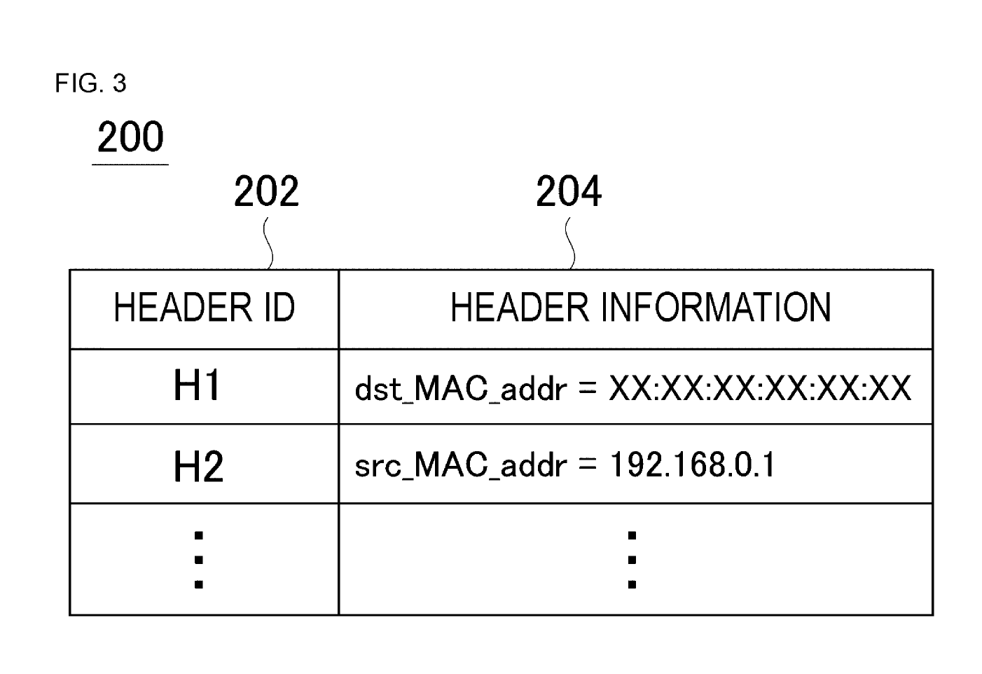

FIG. 3 is a diagram illustrating a set of test headers generated by the test header generation unit 2060, in a table form. This table is denoted as a test header table 200. The test header table 200 has a header ID 202 and header information 204. The header ID 202 is an ID of a test header. The header information 204 is information that the test header indicates. For example, a record of a first row in FIG. 3 indicates that the MAC address of the host 10 being a destination is XX:XX:XX:XX:XX:XX. In addition, a record of a second row in FIG. 3 indicates that the IP address of the host 10 being a transmission source is 192.168.0.1.

<Test Data Generation Unit 2080>

The test data generation unit 2080 generates test data. The test data is a virtual packet group used for simulating an operation of the network system 40.

First, the test data generation unit 2080 generates a direct-product set between a set of the hosts 10 and a set of the test headers generated by the test header generation unit 2060. This direct-product set is denoted as a test packet set. In addition, each element included in the test packet set is denoted as a test packet. The test packet is a combination of “the host 10 and the test header”. Suppose that a test packet A is a combination of “the host A and the test header A”. This test packet A is used for simulating that a packet including information in a header, which information is indicated by the test header A, is transmitted from the host A. The path setting verification device 2000 simulates an operation of the network system 40 using all the combinations of “the host 10 and the test header”. Specifically, the device simulates that a packet executing any of event handlers indicated by the path setting information is transmitted from the host 10.

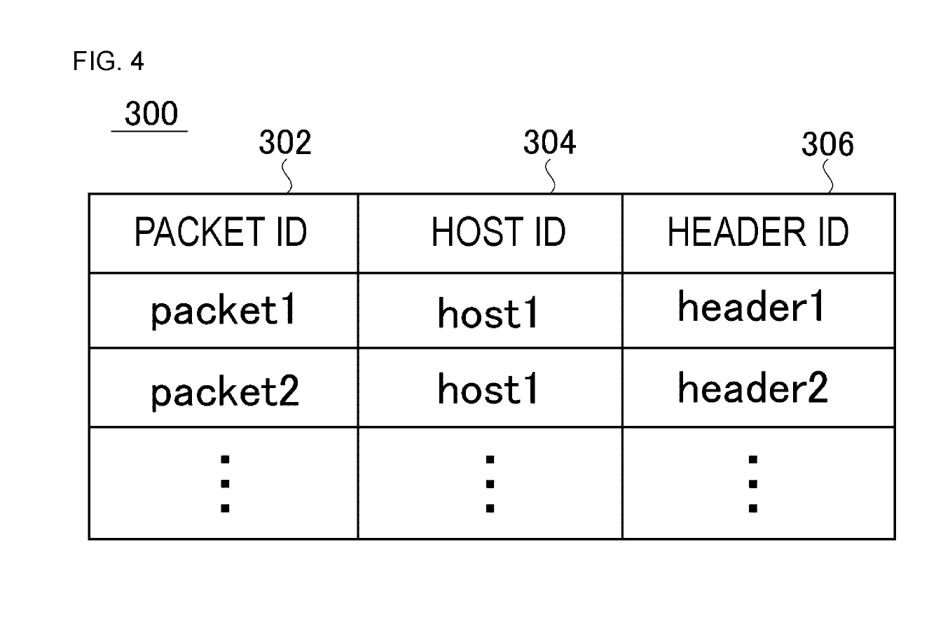

FIG. 4 is a diagram illustrating a test packet set generated by the test data generation unit 2080 in a table form. This table is denoted as a test packet table 300. The test packet table 300 indicates a packet ID 302, a host ID 304, and a header ID 306. The packet ID 302 indicates an ID of a test packet. The host ID 304 is an ID of the host 10 indicated by the test packet. The header ID 306 is an ID of a test header indicated by the test packet. The test packet indicated by each record of the test packet table is used for simulating that a packet including information indicated by a test header identified by the header ID 306 in a header is transmitted from the host 10 identified by the host ID 304.

Further, the test data generation unit 2080 generates all permutations being able to be generated using all the test packets included in the test packet set. Each of the permutations is denoted as a test packet sequence. Suppose that n test packets are included in the test packet set, the number of test packet sequences is equal to n!. For example, the test data generation unit 2080 ranks and arranges the IDs of the test packets, thereby generating test packet sequences. For example, when the test packet set is “host 1, host 2, and host 3”, the test data generation unit 2080 generates six test packet sequences such as “host 1, host 2, and host 3”, “host 1, host 3, and host 2”, “host 2, host 1, and host 3”, “host 2, host 3, and host 1”, “host 3, host 1, and host 2”, and “host 3, host 2, and host 1”. For example, when the path setting verification device 2000 performs a simulation on the test packet sequence of “host 1, host 2, and host 3”, the device simulates that test packets are transmitted in order of a test packet having an ID of host 1, a test packet having an ID of host 2, and a test packet having an ID of host 3.

<Virtual Path Table Set Storage Unit 2100>

The path setting verification device 2000 simulates a change in the path table held by each switch 20 in order to simulate the operation of the network system 40. To do so, the virtual path table set storage unit 2100 stores a set of each path table simulated by the path setting verification device 2000. Here, the path table simulated by the path setting verification device 2000 is denoted as a virtual path table. The virtual path table is associated with one switch 20. The virtual path table associated with the switch 20 is a table obtained by the path setting verification device 2000 simulating a path table held by the switch 20. A set of virtual path tables stored by the virtual path table set storage unit 2100 is denoted as a virtual path table set.

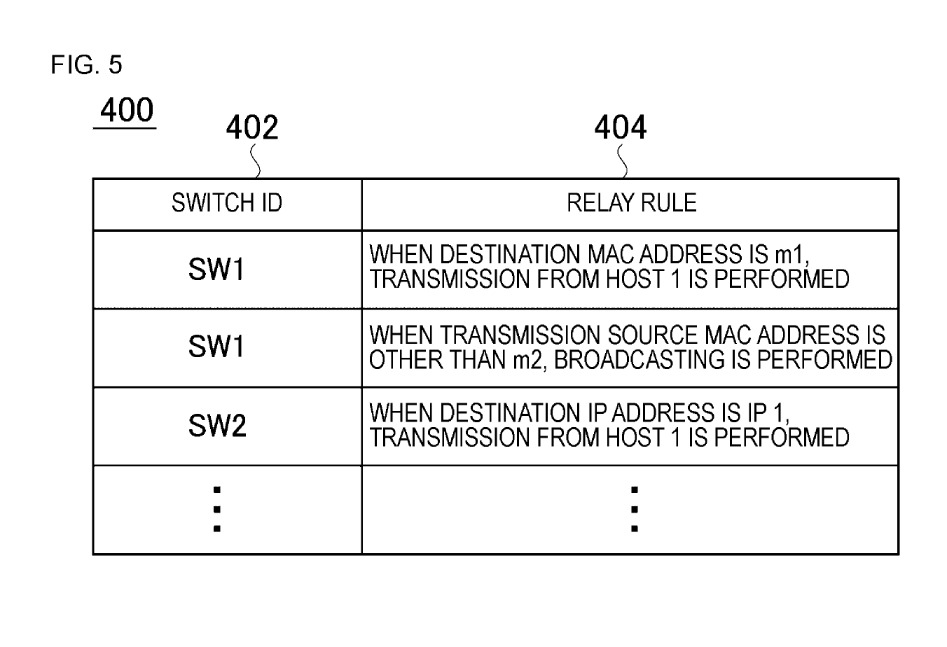

FIG. 5 is a diagram illustrating the configuration of a virtual path table set stored by the virtual path table set storage unit 2100 in a table form. This table is denoted as a virtual path table set table 400. Each record of the virtual path table set table 400 shows that a virtual path table of a switch identified by the switch ID 402 includes a relay rule indicated in a relay rule 404. Here, a set of only records having the same switch ID 402 among the records included in the virtual path table set table 400 indicates a virtual path table corresponding to the switch 20 identified by the switch ID 402.

<Switch Simulation Unit 2120>

The switch simulation unit 2120 simulates an operation of the switch 20. The switch simulation unit 2120 uses a virtual path table corresponding to the switch 20 in order to simulate the operation of the switch 20.

The switch simulation unit 2120 operates in the following flow. First, the switch simulation unit 2120 extracts one test packet sequence from test data generated by the test data generation unit 2080. Next, the switch simulation unit 2120 sequentially extracts test packets from the extracted one test packet sequence. Here, the switch simulation unit 2120 extracts the test packets in order of being ranked in the test packet sequence. The operations of the switches 20 are sequentially simulated with respect to each of the test packets. When the simulation of the operations of the switches 20 is terminated with respect to all the test packets included in one test packet sequence, the switch simulation unit 2120 extracts the next test packet sequence from the test data. Note that, before performing a simulation on one test packet sequence, the switch simulation unit 2120 initializes each virtual path table stored in the virtual path table set storage unit 2100. In this manner, how a path setting transitions from an initial state is simulated with respect to each test packet sequence. Note that, the contents of the virtual path table in an initial state are the same as the contents of the path tables of each switch 20 in an initial state. For example, the path table in an initial state does not have any one of relay rules. Besides, for example, the path table in an initial state has a relay rule given in advance before running. For example, a relay rule of “discarding a packet which does not meet any other relay rules” is set in advance before running, and thus all the unexpected packets may be discarded.

The switch simulation unit 2120 repeatedly performs the above operations on all the test packet sequences. Here, the order in which the switch simulation unit 2120 extracts the test packet sequences is arbitrary.

Next, a simulation of the operation of the switch 20 performed on one test packet by the switch simulation unit 2120 will be described. First, the switch simulation unit 2120 specifies a switch 20 connected to a host 10 that the test packet indicates. A simulation for a case where the switch 20 receives a packet having information included in a test header indicated by the test packet is performed. Specifically, a relay process performed by the switch 20 on the packet is simulated. When this relay process involves the transmission of a control request, the control device simulation unit 2140 described later simulates a control process of processing this control request.

<Control Device Simulation Unit 2140>

The control device simulation unit 2140 simulates an operation performed by a control device. Specifically, when the relay process simulated by the switch simulation unit 2120 involves the transmission of a control request, a control process performed on the control request by the control device 30 is simulated. When this control process involves an update of the path table, the control device simulation unit 2140 updates the contents of the virtual path table obtained by simulating this path table. The contents of the update are the same as the contents of the update added to the path table by the control process.

<Path Setting Verification Unit 2160>

The path setting verification unit 2160 verifies the validity of a path setting represented by the virtual path table set, using the topology information and the virtual path table set. Here, examples of the path setting being invalid include a case where the switch 20 does not relay a packet to be relayed, a case where a packet loops through the network system 40, and the like. For example, when there is an error in an execution condition indicated by the path setting information, an event handler to be executed is not executed. Thus, a relay rule regarding a packet to be relayed by the switch 20 is not added to the path table of the switch 20. As a result, even when a packet to be relayed is received, the switch 20 is not able to acquire a relay rule regarding the packet, and thus is not able to relay the packet. Therefore, this packet does not reach a destination to be reached when the path setting is correctly performed. This means that information is not able to be correctly transmitted between the hosts.

Note that, a method of determining whether each path setting is valid is a well-known technique, and thus the description thereof will not be repeated. This method is disclosed in, for example, Non-Patent Document 2.

<Hardware Configuration>

Each functional configuration unit included in the path setting verification device 2000 is implemented with, for example, at least one hardware component in a state where individual or a plurality of units are combined. Besides, for example, each functional configuration unit is implemented with at least one software component. Besides, for example, each functional configuration unit is implemented with a combination of hardware components and software components.

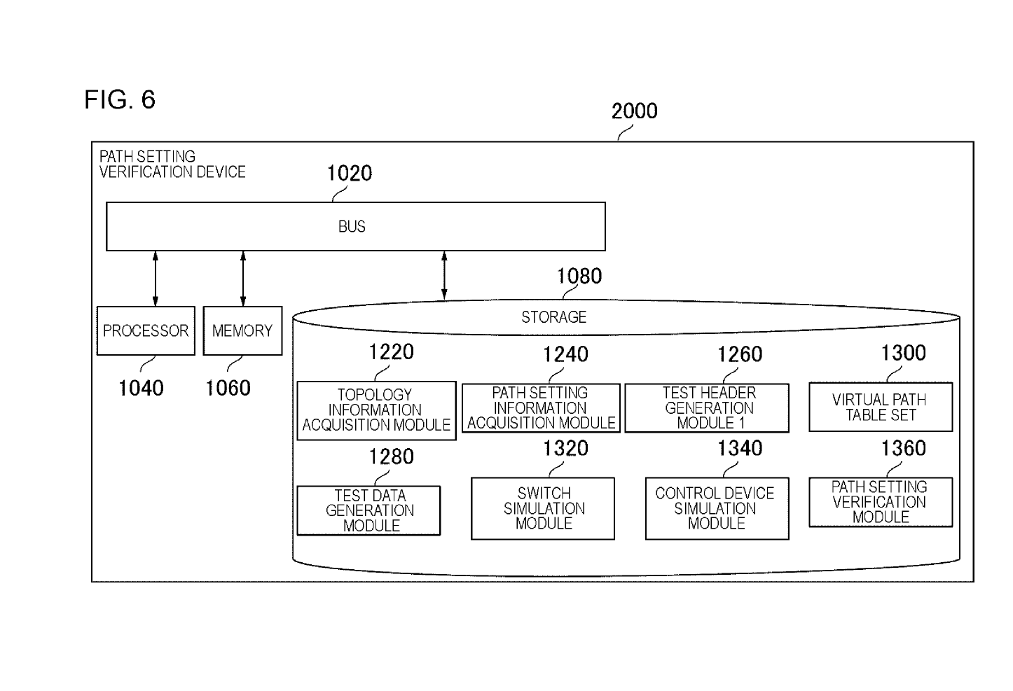

FIG. 6 is a block diagram illustrating a hardware configuration of the path setting verification device 2000. In FIG. 6, the path setting verification device 2000 includes a bus 1020, a processor 1040, a memory 1060, and a storage 1080.

The bus 1020 is a data transmission channel in order for the processor 1040, the memory 1060 and the storage 1080 to mutually transmit and receive data. The processor 1040 is an arithmetic processing unit such as, for example, a CPU (Central Processing Unit) or a GPU (Graphics Processing Unit). The memory 1060 is a memory such as, for example, a RAM (Random Access Memory) or a ROM (Read Only Memory). The storage 1080 is a storage device such as, for example, a memory card, a hard disk, or an SSD (Solid State Drive). In addition, the storage 1080 may be a memory such as a RAM or a ROM.

A topology information acquisition module 1220 is a program for causing the path setting verification device 2000 to have a function of the topology information acquisition unit 2020. The processor 1040 realizes the function of the topology information acquisition unit 2020 by executing the topology information acquisition module 1220.

A path setting information acquisition module 1240 is a program for causing the path setting verification device 2000 to have a function of the path setting information acquisition unit 2040. The processor 1040 realizes the function of the path setting information acquisition unit 2040 by executing the path setting information acquisition module 1240.

A test header generation module 1260 is a program for causing the path setting verification device 2000 to have a function of the test header generation unit 2060. The processor 1040 realizes the function of the test header generation unit 2060 by executing the test header generation module 1260.

A test data generation module 1280 is a program for causing the path setting verification device 2000 to have a function of the test data generation unit 2080. The processor 1040 realizes the function of the test data generation unit 2080 by executing the test data generation module 1280.

A switch simulation module 1320 is a program for causing the path setting verification device 2000 to have a function of the switch simulation unit 2120. The processor 1040 realizes the function of the switch simulation unit 2120 by executing the switch simulation module 1320.

A control device simulation module 1340 is a program for causing the path setting verification device 2000 to have a function of the control device simulation unit 2140. The processor 1040 realizes the function of the control device simulation unit 2140 by executing the control device simulation module 1340.

A path setting verification module 1360 is a program for causing the path setting verification device 2000 to have a function of the path setting verification unit 2160. The processor 1040 realizes the function of the path setting verification unit 2160 by executing the path setting verification module 1360.

For example, the processor 1040 reads out and executes each of the modules on the memory 1060. However, the processor 1040 may execute each of the modules without reading out the modules on the memory 1060.

The storage 1080 stores a virtual path table set 1300. In this manner, the storage 1080 realizes a function of the virtual path table set storage unit 2100. In addition, the storage 1080 stores each of the modules.

The hardware configuration of the path setting verification device 2000 is not limited to the configuration shown in FIG. 6. For example, each of the modules may be stored in the memory 1060. In this case, the path setting verification device 2000 may not include the storage 1080. In addition, the path setting verification device 2000 may be constituted by a plurality of computers. For example, the path setting verification device 2000 may be constituted by a computer including the topology information acquisition unit 2020, the path setting information acquisition unit 2040, the test header generation unit 2060, the test data generation unit 2080, the virtual path table set storage unit 2100, the switch simulation unit 2120, and the control device simulation unit 2140 that simulate the operation of the network system 40, and another computer including the path setting verification unit 2160 that verifies the validity of each path setting generated by the simulation.

<Flow of Processes>

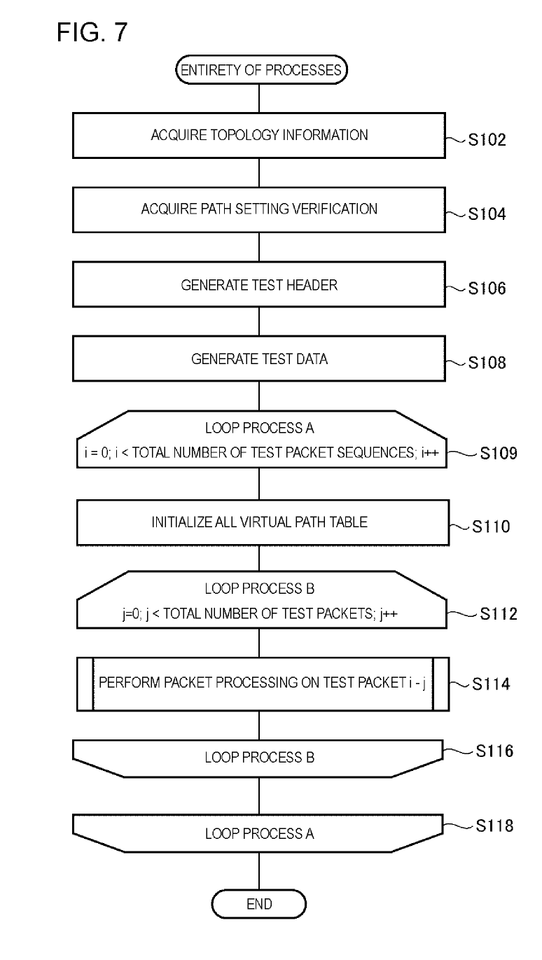

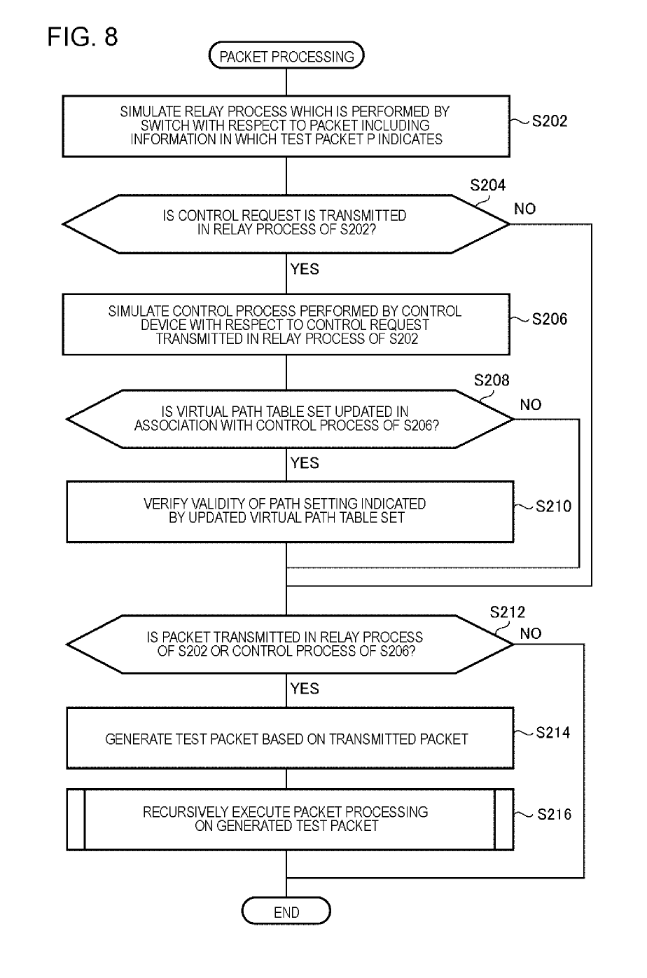

A flow of processes executed by the path setting verification device 2000 of Exemplary embodiment Twill be described with reference to FIGS. 7 and 8. FIG. 7 illustrates a flow of the entirety of processes, which is a whole process performed by the path setting verification device 2000 of Exemplary embodiment 1. FIG. 8 illustrates a flow of packet processing, which is a process relating to one test packet. The packet processing is invoked in the whole process.

<<Whole Process>>

First, a flow of the whole process will be described with reference to FIG. 7. In step S102, the topology information acquisition unit 2020 acquires topology information. In step S104, the path setting information acquisition unit 2040 acquires path setting information. In step S106, the test header generation unit 2060 generates a test header. In step S108, the test data generation unit 2080 generates test data.

Step S109 to step S118 are a loop process A, which is executed on each test packet sequence. The initial value of a counter i used in the loop process A is 0. In addition, whenever the loop process A is executed once, the switch simulation unit 2120 increases a value of i by 1. In step S109, the switch simulation unit 2120 determines whether the relation of “i<the total number of test packet sequences” is satisfied. Here, the relation of “i=the total number of test packet sequences” means that the loop process A has already been executed on all of the test packet sequences. Therefore, when the relation of “i<the total number of test packet sequences” is not satisfied, the whole process is terminated. On the other hand, when the relation of “i<the total number of test packet sequences” is satisfied, the whole process proceeds to step S110. Hereinafter, an i-th test packet sequence is denoted as a test packet sequence i. In step S110, the switch simulation unit 2120 initializes all of the virtual path tables stored in the virtual path table set storage unit 2100.

Step S112 to step S116 are a loop process B, which is executed on each test packet included in the test packet sequence i. The initial value of a counter used in the loop process B is 0. In addition, whenever the loop process B is executed once, the switch simulation unit 2120 increases a value of j by 1. In step S112, the switch simulation unit 2120 determines whether the relation of “j<the total number of test packets” is satisfied. Here, the relation of “j=the total number of test packets” means that the loop process B has already been executed on all of the test packets included in the test packet sequence i. Therefore, when the relation of “j<the total number of test packets” is not satisfied, the whole process proceeds to step S118. On the other hand, when the relation of “j<the total number of test packets” is satisfied, the whole process proceeds to step S114. Hereinafter, a j-th packet of the test packet sequence i is denoted as a test packet i-j. In step S114, the switch simulation unit 2120 performs the packet processing on the test packet i-j. A specific flow of the packet processing will be described later.

Step S116 is a termination of the loop process B. Thus, in step S116, the whole process proceeds to step S112. Step S118 is a termination of the loop process A. Thus, in step S118, the whole process proceeds to step S109.

<<Packet Processing>>

Packet processing of performing a simulation on one test packet will be described with reference to FIG. 8. Here, the test packet input with respect to this packet processing is denoted as a test packet P. The test packet P in the packet processing invoked in step S114 is the test packet

In step S202, the switch simulation unit 2120 simulates a relay process performed by the switch 20. This switch 20 is a switch 20 connected to a transmission source indicated by the test packet P without going through other switches 20. In addition, this relay process is a process performed by the switch 20 on a packet, including information indicated by a test header indicated by the test packet P, in a header.

In step S204, the path setting verification device 2000 checks whether a control request is transmitted in the relay process of step S202. When the control request is transmitted in this relay process, the packet processing proceeds to step S206. On the other hand, when the control request is not transmitted in this relay process, the packet processing proceeds to step S212.

In step S206, the control device simulation unit 2140 simulates a control process performed by the control device 30 on the control request transmitted in the relay process of step S202.

In step S208, the path setting verification device 2000 determines whether the virtual path table set is updated in association with the control process of step S206. When the virtual path table set is updated in association with the control process of step S206, the packet processing proceeds to step S210. On the other hand, when the virtual path table set is not updated in association with the control process of step S206, the packet processing proceeds to step S212.

In step S210, the path setting verification unit 2160 verifies the validity of the path setting represented by the updated virtual path table set. Here, suppose that the path setting verification unit 2160 has already verified the validity of the path setting with respect to a virtual path table set having the same contents as those of the virtual path table set to be verified. In this case, the path setting verification unit 2160 may not verify this virtual path table set. In this manner, the number of times the path setting verification unit 2160 verifies the path setting is reduced, and as a result, the time spent to verify the path setting is shortened. Note that, in this case, it is necessary that the path setting verification unit 2160 is able to specify the virtual path table sets having been verified so far. Consequently, for example, the path setting verification device 2000 includes a storage unit that stores virtual path table sets for which verification has already been finished. Besides, for example, the path setting verification device 2000 may include a storage unit that stores the virtual path table sets having been generated so far in association with a graph indicating whether verification has already been finished.

Here, when determining whether two virtual path table sets have the same contents, it may be determined that the two virtual path table sets have the same contents only when the contents of the relay rule and the order indicated by each relay rule are the same as each other, or it may be determined to have the same contents when the contents of the relay rules are the same with each other without considering the order. Note that, the determination without considering the order indicated by the relay rules results in an increase in the number of virtual path table sets determined to have the same contents. Thus, the number of times the path setting verification unit 2160 verifies the path setting is reduced, and as a result, the time spent to verify the path setting is shortened.

In step S212, the path setting verification device 2000 checks whether a packet is transmitted in the relay process simulated in step S202 or the control process simulated in step S206. When a packet is transmitted in these processes, the packet processing proceeds to step S214. On the other hand, when a packet is not transmitted in these processes, the packet processing is terminated.

In step S214, the path setting verification device 2000 generates test packets based on the packet transmitted by the relay process simulated in step S202 and the packet transmitted in the control process simulated in step S206, respectively. A transmission source indicated by the test packet is the switch 20 simulated by the switch simulation unit 2120. A test header indicated by the test packet depends on the relay process simulated by the switch simulation unit 2120 or depends on the contents of the control process simulated by the control device simulation unit 2140.

In step S216, the packet processing shown in FIG. 8 is recursively executed on the generated test packet. When there are a plurality of packets transmitted, the packet processing is recursively executed on a test packet corresponding to each of the plurality of packets.

<Operational Effects>

The path setting verification device 2000 generates a header (test header) of a packet for satisfying an execution condition in which each event handler indicated by the path setting information is executed, using the path setting information used by the control device 30 of the network system 40. The behavior of the network system 40 is simulated on a permutation (test packet sequence) in which elements (test packets) included in all the combinations of the test headers and the hosts included in the network system 40 are arranged in any order. In this manner, according to path setting verification device 2000 of the present exemplary embodiment, a value shown in the header of a packet to be simulated is extracted from the path setting information used by the control device 30, without using a method requiring a long time in execution such as symbolic execution. By this method, the time of a simulation is shortened as compared to the use of symbolic execution. Thus, the time of a simulation is short as compared to an existing technique. Thereby, the time spent to verify the path setting of the network system 40 is shortened.

In addition, the path setting verification device 2000 does not simulate information having no influence on the transition of a path setting such as the state of a packet queue included in the switch 20, which is a part of the states of the network system 40. Thus, the time spent for a simulation is shorter as compared to an existing technique. Thereby, the time spent to verify the path setting of the network system 40 becomes shorter.

### Exemplary Embodiment 2

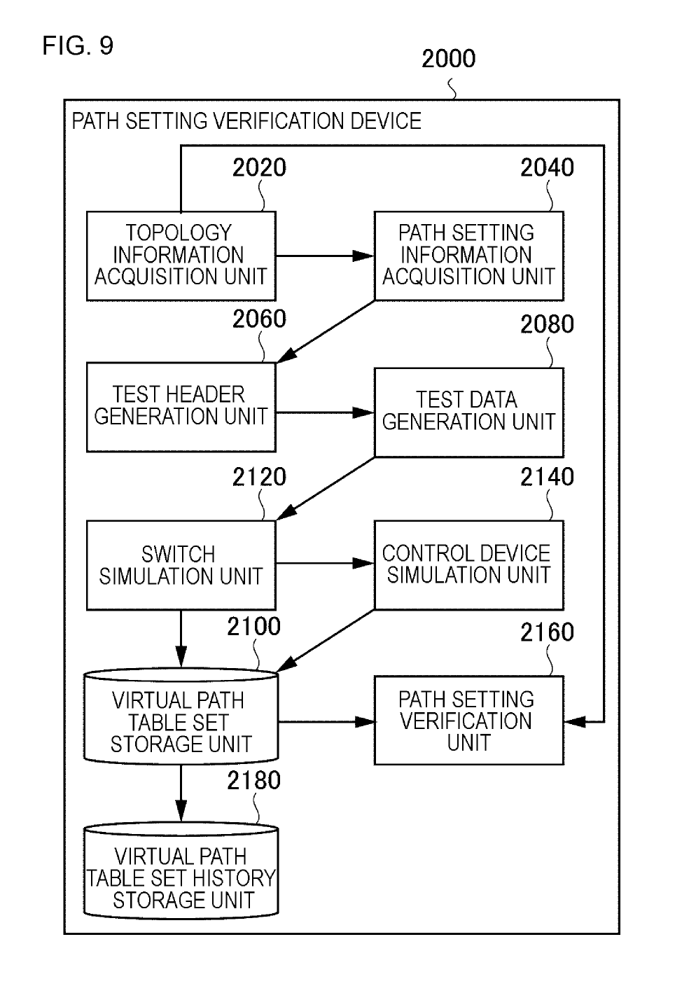

FIG. 9 is a block diagram illustrating a path setting verification device 2000 according to Exemplary embodiment 2. In FIG. 9, a flow of arrows indicates a flow of information. In addition, in FIG. 9, each block represents a function-based block rather than a hardware-based configuration.

The path setting verification device 2000 of Exemplary embodiment 2 is different from the path setting verification device 2000 of Exemplary embodiment 1, in that it includes a virtual path table set history storage unit 2180, which stores a history of virtual path table sets generated when the operation of the network system 40 is simulated. Hereinafter, a detailed description will be given.

<Virtual Path Table Set History Storage Unit 2180>

The virtual path table set history storage unit 2180 stores a history of virtual path table sets. For example, when any of the virtual path tables stored is updated, the virtual path table set storage unit 2100 stores copies of all the stored virtual path tables (virtual path table sets) in the virtual path table set history storage unit 2180 before the update. In this manner, each virtual path table set generated when the path setting verification device 2000 simulates the operation of the network system 40 is stored in the virtual path table set history storage unit 2180. Here, as described above, the virtual path table set indicates a path setting in the network system 40. Thus, it can also be described that the virtual path table set history storage unit 2180 stores an update history of path settings in the network system 40.

Note that, a method of storing a history of virtual path table sets is not limited to the above-mentioned method of copying virtual path tables stored by the virtual path table set storage unit 2100. For example, when any of the virtual path tables is updated in the relay process to be simulated, the switch simulation unit 2120 copies all the virtual path tables stored in the virtual path table set storage unit 2100 before the update is perform, and stores the resultants in the virtual path table set history storage unit 2180.

In addition, the switch simulation unit 2120 or the virtual path table set storage unit 2100 may not store a virtual path table set, if a virtual path table set having the same contents has already been stored when storing the virtual path table set in the virtual path table set history storage unit 2180. Thereby, the data size of the virtual path table set stored in the virtual path table set history storage unit 2180 is reduced. In addition, thereby, the path setting verification unit 2160 that performs a verification using the virtual path table stored in the virtual path table set history storage unit 2180 can be prevented from duplicating a verification relating to the same virtual path table set. Therefore, the efficiency of a verification performed by the path setting verification device 2000 is improved.

Note that, when determining whether two virtual path table sets have the same contents, it may be determined that two virtual path table sets have the same contents only if the contents of the relay rule and the order indicated by each relay rule are the same as each other, or may be determined so if the contents of the relay rules are coincident with each other without considering the order. Note that, the determination without considering the order indicated by the relay rule results in a decrease in the number of virtual path table set histories. Thus, the number of times the path setting verification unit 2160 verifies the path setting is reduced, and as a result, the time spent for verifying the path setting is shortened. In addition, the size of a storage area required to implement the virtual path table set history storage unit 2180 is reduced.

In addition, the virtual path table set history storage unit 2180 may store the virtual path table sets so that the virtual path table sets before and after update are associated with each other. In this manner, a flow of the transitions of the virtual path table sets is stored in the virtual path table set history storage unit 2180. That is, a flow of the changes of the path setting in the network system 40 is stored in the virtual path table set history storage unit 2180.

<Path Setting Verification Unit 2160>

The path setting verification unit 2160 of Exemplary embodiment 2 verifies the validity of each path setting represented by each of a plurality of virtual path table sets stored in the virtual path table set history storage unit 2180. For example, after a simulation is finished with respect to all the test packet sequences, the path setting verification unit 2160 verifies each of the virtual path table sets stored in the virtual path table set history storage unit 2180.

<Flow of Processes>

In the packet processing of FIG. 8, the path setting verification device 2000 of Exemplary embodiment 2 performs a process of storing the virtual path table set before update, instead of S210. In addition, in the whole process of FIG. 7, the path setting verification device 2000 of Exemplary embodiment 2 verifies the validity of each path setting represented by each of the virtual path table sets stored in the virtual path table set history storage unit 2180, after S118.

<Operational Advantages>

According to the path setting verification device 2000 of Exemplary embodiment 2, all the virtual path table sets generated when the simulation of the network system 40 is performed are stored in the virtual path table set history storage unit 2180. In addition, the path setting verification unit 2160 of Exemplary embodiment 2 verifies the validity of each path setting represented by each of a plurality of virtual path table sets stored in the virtual path table set history storage unit 2180. In this manner, unlike a case where the validity of the virtual path table set is verified whenever a virtual path table set to be verified is generated, the simulation of the network system 40 and a process of verifying the validity of each path setting generated in the simulation are obviously separated from each other. Thus, the design of the path setting verification device 2000 becomes simpler. For example, the path setting verification device 2000 can be easily divided into a computer performing the simulation of the network system 40 and another computer performing the process of verifying the validity of the path setting.

### Exemplary Embodiment 3

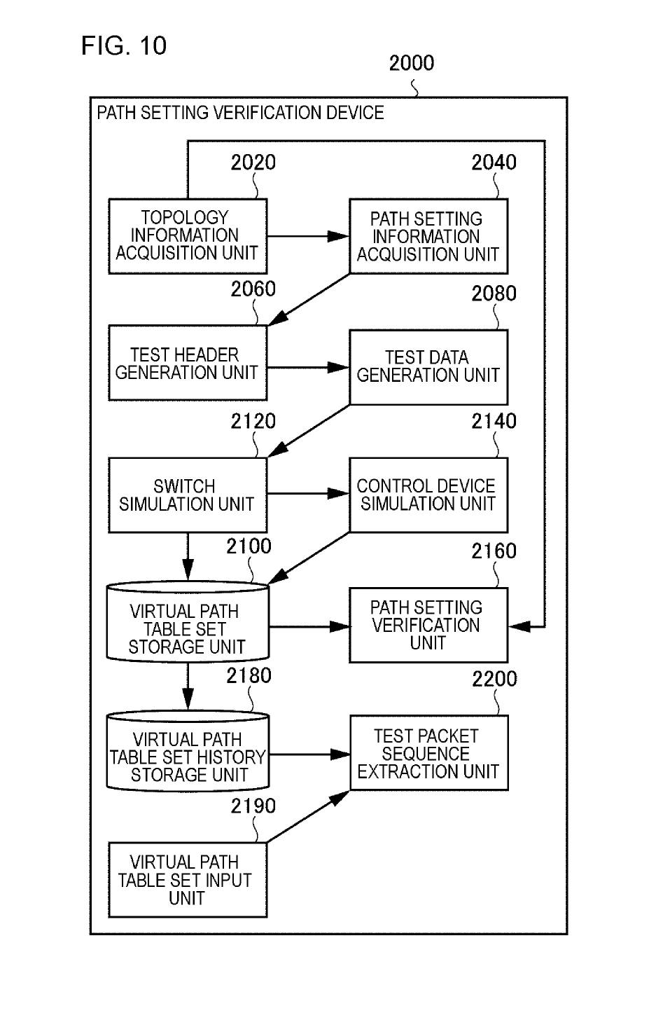

FIG. 10 is a block diagram illustrating a path setting verification device 2000 according to Exemplary embodiment 3. In FIG. 10, a flow of arrows indicates a flow of information. In addition, in FIG. 10, each block represents a function-based block rather than a hardware-based configuration.

<Virtual Path Table Set History Storage Unit 2180>

The virtual path table set history storage unit 2180 of Exemplary embodiment 3 stores a virtual path table set in association with the ID of the test packet sequence used in a simulation when the virtual path table set is generated. Here, suppose that a virtual path table set having the same contents as those of a virtual path table set is stored in the virtual path table set history storage unit 2180 in advance, when the virtual path table set is stored in the virtual path table set history storage unit 2180. In this case, the switch simulation unit 2120 or the virtual path table set storage unit 2100 that stores the virtual path table set in the virtual path table set history storage unit 2180 further associates the ID of the test packet sequence being currently simulated with the virtual path table set having the same contents which is stored in advance. In this manner, each test packet sequence for generating the virtual path table set is associated with one virtual path table set. Note that, as is the case with Exemplary embodiment 2, when determining whether two virtual path table sets have the same contents, it may be determined that the two virtual path table sets have the same contents only if the contents of the relay rule and the order indicated by each relay rule are the same as each other, or may be determined so when the contents of the relay rules are coincident with each other without considering the order.

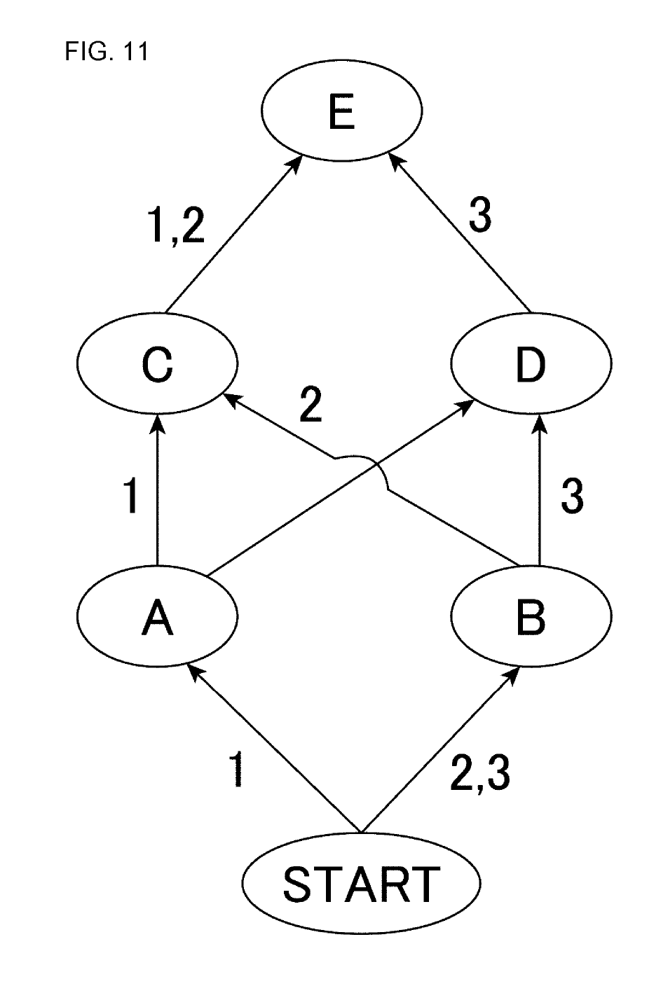

FIG. 11 is a digraph conceptually illustrating a state transition of virtual path table sets. A to E are IDs of each virtual path table set. START indicates a path table set in an initial state. Values attached to arrows are IDs of the test packet sequence simulated when the state of the virtual path table set transitions in the direction of the arrow. For example, the update of the virtual path table set from an initial state to a virtual path table set A is a case where the switch simulation unit 2120 performs a simulation on the test packet sequence 1. Therefore, the virtual path table set history storage unit 2180 stores the virtual path table set A in association with the test packet sequence 1. Similarly, the virtual path table set history storage unit 2180 stores a virtual path table set B in association with the test packet sequences 2 and 3, stores a virtual path table set C in association with the test packet sequences 1 and 2, stores a virtual path table set D in association with the test packet sequence 3, and stores a virtual path table set E in association with the test packet sequences 1 to 3. In this manner, the transition of the virtual path table sets as shown in FIG. 11 can be indicated by information stored in the virtual path table set history storage unit 2180.

Note that, the virtual path table set history storage unit 2180 may further associate the virtual path table set with the ID of the test packet simulated when the virtual path table set is generated.

<Virtual Path Table Set Input Unit 2190>

A virtual path table set input unit 2190 accepts an input of the virtual path table set. Here, the ID of the virtual path table set may be input to the virtual path table set input unit 2190. This ID is, for example, an ID allocated to each virtual path table set stored in the virtual path table set history storage unit 2180.

<Test Packet Sequence Extraction Unit 2200>

A test packet sequence extraction unit 2200 extracts a test packet sequence corresponding to the virtual path table set which is input to the virtual path table set input unit 2190, from the virtual path table set history storage unit 2180. In this manner, a test packet sequence required to generate a target virtual path table set is extracted. By extracting the test packet sequence required to generate the target virtual path table set, it can be figured out that in order to generate the target virtual path table set, from which host and in what order the packets indicating a certain kind of information has to be transmitted.

In addition, when the virtual path table set history storage unit 2180 stores the virtual path table set in association with the test packet sequence and the test packet, the test packet sequence extraction unit 2200 may extract a combination of the test packet sequence and the test packet corresponding to the acquired virtual path table set. In this manner, it can be figured out that in order to generate the target virtual path table set, which test packet among those indicated by the test packet sequence is required.

The path setting verification device 2000 of Exemplary embodiment 3 may have a function of outputting a state transition diagram of the virtual path table sets as shown in FIG. 10 based on the history of the virtual path table sets stored in the virtual path table set history storage unit 2180. For example, a user of the path setting verification device 2000 sees this state transition diagram, and selects a virtual path table set desired to be verified. The virtual path table set input unit 2190 accepts this selected virtual path table set as an input. In this manner, a user can easily determine for which virtual path table set the verification is performed.

<Operational Advantages>

According to Exemplary embodiment 3, it can be figured out that in order to set the path setting of the network system 40 to a target path setting, from which host and in what order the packets indicating a certain kind of information has to be transmitted.

The path setting verification device 2000 of Exemplary embodiment 3 is useful, for example, when specific validity is desired to be verified with respect to the path setting of the network system 40. For example, in the network system 40, the amount of data of each path table may increase beyond expectations. This is generally called a path overflow. For this reason, before starting running the network system 40, it is useful to confirm that the path overflow does not occur in the network system 40. Here, in order to confirm whether the path overflow occurs, a path setting should be verified for a case where the size of each path table becomes largest. For example, when the transition of the virtual path table sets are represented by the digraph as shown in FIG. 11, that is a virtual path table set being in the end of state transition. In a case of FIG. 11, it is the virtual path table set E. Consequently, the virtual path table set E is input to the virtual path table set input unit 2190, and thus it is possible to acquire a test packet sequence required to verify a path table overflow from the test packet sequence extraction unit 2200.

### Example

Hereinafter, an example of the path setting verification device 2000 will be described. In the example described below, OpenFlow is used for a dynamic path setting. Thus, the event handler indicated by the path setting information executes any one or more of a flow_mod command and a pkt_out command, which are commands based on OpenFlow. The flow_mod command is a command for adding a relay rule to the path table of the switch 20. The control device simulation unit 2140 simulates the flow_mod command by performing the update of the virtual path table. The pkt_out command is a command for causing a designated switch 20 to transmit a packet. When the control device simulation unit 2140 simulates the pkt_out command, a packet is transmitted in association with a control command, and thus the switch simulation unit 2120 recursively executes the packet processing of FIG. 8.

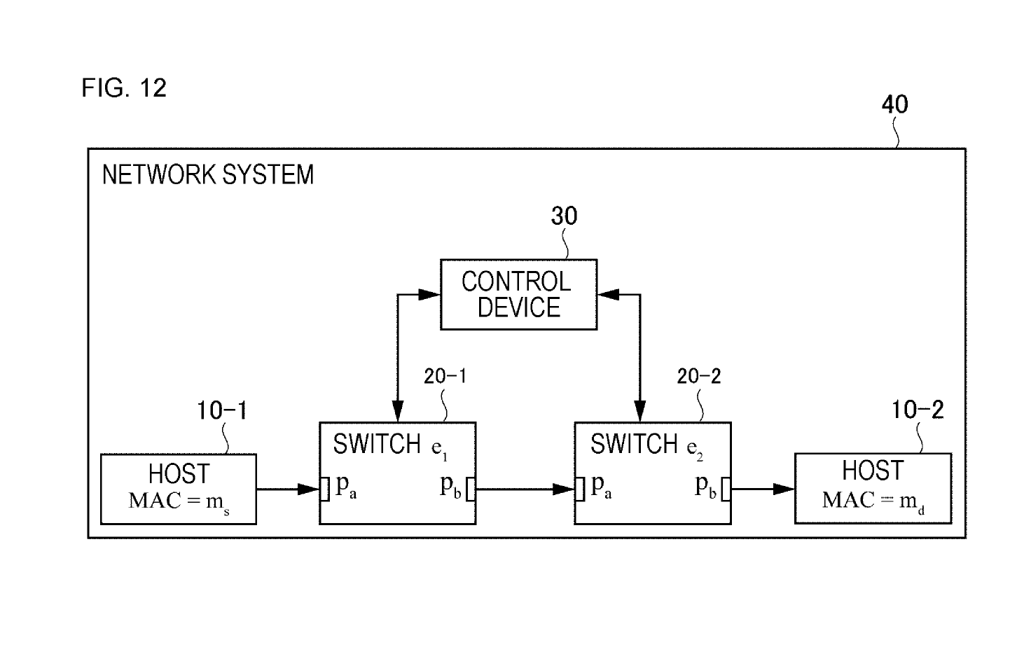

FIG. 12 is a block diagram illustrating a configuration of a network system 40 in the example. The network system 40 includes two hosts 10-1 and 10-2, two switches 20-1 and 20-2, and a control device 30. The MAC address of the host 10-1 is ms, and the MAC address of the host 10-2 is md. In addition, the host 10-1 transmits a packet, but does not receive a packet. On the other hand, the host 10-2 receives a packet, but does not transmit a packet. The switches 20-1 and 20-1 are also denoted as switches e1 and e2, respectively.

The packet transmitted to the switch 20-1 by the host 10-1 is received by the port pa of the switch 20-1. The packet transmitted from the port pb of the switch 20-1 is received by the port pa of the switch 20-2. The packet transmitted from the port pb of the switch 20-2 is received by the host 10-2.

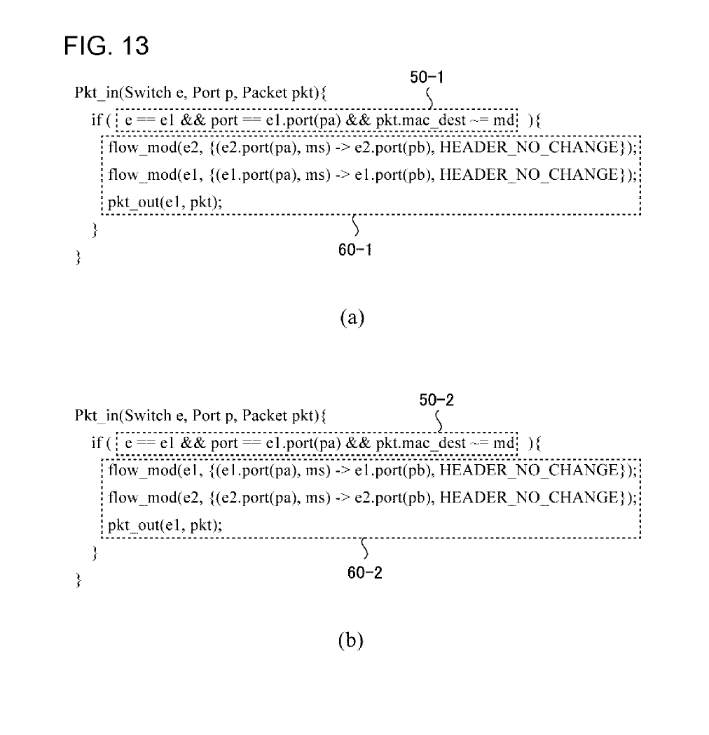

FIG. 13 is a diagram illustrating execution conditions and event handlers indicated by path setting information in the example. The execution conditions are 50-1 in FIGS. 13(a) and 50-2 in FIG. 13(b). In addition, the event handlers are 60-1 in FIG. 13(a) and 60-2 in FIG. 13(b). The execution conditions 50-1 and 50-2 are the same as each other.

The execution conditions 50-1 and 50-2 are logical products of three conditions such as “a switch transmitting a control request is the switch e1”, “the port pa of the switch e1 receives a packet”, and “the destination MAC address of the received packet is md”. That is, when all these three conditions are satisfied, the event handler is executed.

Three commands included in the event handler 60-1 have the following meanings. First, flow_mod in a first row is a command for setting a relay rule of “when a packet having the transmission source MAC address of ms is received by the port pa of the switch e2, the packet is transmitted from the port pb of e2” for the switch e2. HEADER_NO_CHANGE is a flag for specifying “the contents of the header of the packet are not changed”. Next, flow_mod in a second row is a command for setting a relay rule of “when a packet having the transmission source MAC address of ms is received by the port pa of the switch e1, the packet is transmitted from the port pb of e1” for the switch e1. In addition, pkt_out in a third row is a command for instructing the switch e1 to transmit a packet. Note that, the event handler 60-2 is equivalent to the replacement of a command in a first row by a command in a second row in the event handler 60-1.

In the above assumption environment, the path setting verification device 2000 is run. Here, a case where the control device 30 uses the path setting information shown in FIG. 13(a) is set to Case 1, and a case where the control device 30 uses the path setting information shown in FIG. 13(b) is set to Case 2.

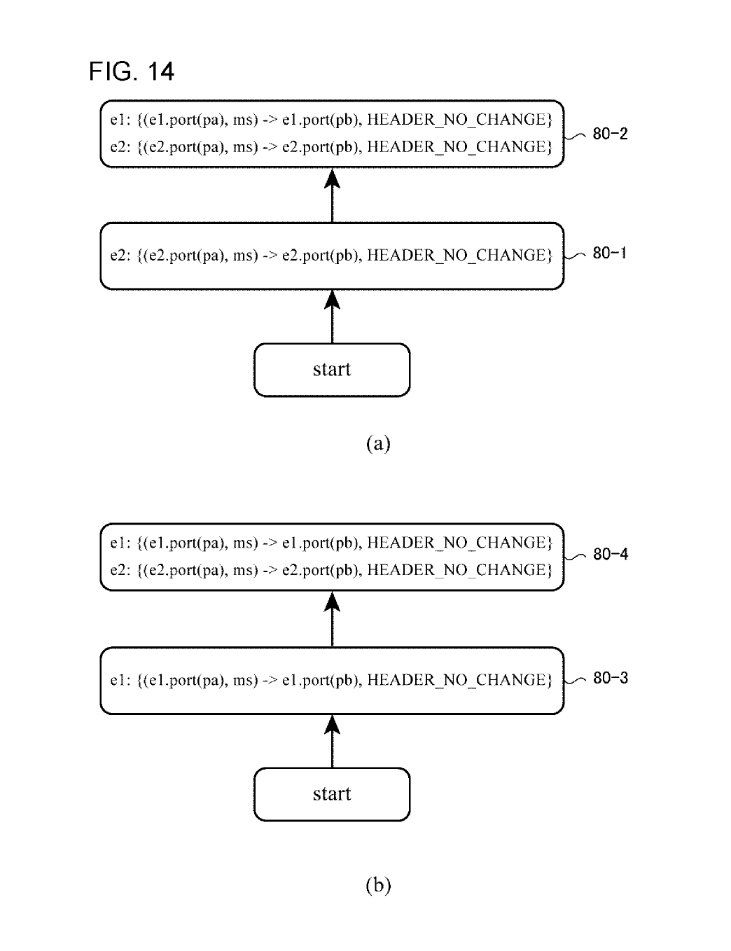

FIG. 14 is a diagram illustrating a transition of virtual path table sets when the path setting verification device 2000 is run in Case 1 and Case 2. FIG. 14(a) shows Case 1, and FIG. 14(b) shows Case 2. When the path setting verification device 2000 simulates the flow_mod command described in the first row of the event handler 60-1, the virtual path table set is changed into a virtual path table set 80-1. Next, when the path setting verification device 2000 simulates the flow_mod command described in the second row of the event handler 60-1, the virtual path table set is changed into a virtual path table set 80-2.

On the other hand, when the path setting verification device 2000 simulates the flow_mod command described in the first row of the event handler 60-2, the virtual path table set is changed into a virtual path table set 80-3. Next, when the path setting verification device 2000 simulates the flow_mod command described in the second row of the event handler 60-1, the virtual path table set is changed into a virtual path table set 80-4. Note that, the virtual path table sets 80-2 and 80-4 have the same contents.

Here, in Case 1, all the path settings are valid. However, in Case 2, the path setting indicated by the virtual path table set 80-3 is invalid. Hereinafter, in Case 2, the operation of the path setting verification device 2000 will be described in detail.

First, the topology information acquisition unit 2020 acquires topology information indicating a connection relationship between the host 10-1 and the switch 20-1, a connection relationship between the host 10-2 and the switch 20-2, and a connection relationship between the switch 20-1 and the switch 20-2. In addition, the topology information further indicates that the host 10-2 does not transmit a packet. The path setting information acquisition unit 2040 acquires the path setting information shown in FIG. 13(b).

The test header generation unit 2060 generates a test header from the path setting information. Information being possible to be included in the header in the execution condition 50-2 shown in FIG. 13(b) is only the destination MAC address of md. Consequently, the test header generation unit 2060 generates a test header such as “header ID: header 1, and destination MAC address: md”.

The test data generation unit 2080 generates a test packet set using a set of the hosts 10 and a set of the test headers. Here, in order to generate a test packet set, the test data generation unit 2080 uses only the host 10 transmitting a packet with reference to the topology information. Thus, a set of the hosts 10 is “ms”. In addition, a set of the test headers is the “header 1”. Thus, the test packet set is a set having only a test packet of “ms, header 1” (hereinafter, test packet 1). Therefore, the test packet sequence included in test data is one test packet sequence having only the test packet 1.

The switch simulation unit 2120 performs a simulation on the above test packet sequence (packet processing of FIG. 8). Here, suppose that the initial state of the virtual path table set is empty. Since the transmission source of the test packet 1 is ms, the switch simulation unit 2120 simulates a relay process executed by the switch 20-1 connected to the host 10-1 (step S202). Information included in the header of the packet received by the switch 20-1 includes “destination MAC address=md” indicated by the test header of the test packet 1.

Here, the path table of the switch 20-1 is empty, and thus does not have a relay rule for transmitting this packet. Then, the switch 20-1 transmits a control request to the control device 30. This control request includes information such as “the transmission source of the control request is the switch 20-1”, information such as “the port receiving a packet is the port pa”, the contents of the test header, and the like.

The control device simulation unit 2140 simulates the operation of the control device 30 having received the above control request (step S206). Here, information indicated by the packet header satisfies all of the execution condition 50-2. Therefore, the control device simulation unit 2140 simulates the event handler 60-2. As described above, FIG. 14(b) represents the state transition of the virtual path table set in Case 2.

First, the control device simulation unit 2140 simulates the flow_mod command in a first row of the event handler 60-1. By doing so, the virtual path table set is changed into the virtual path table set 80-3 shown in FIG. 14(b). Here, since the virtual path table is updated, the path setting verification unit 2160 verifies the validity of the path setting represented by the virtual path table set 80-3 (step S210).

Suppose that the host 10-1 transmits a packet when the path setting is represented by the virtual path table set 80-3. This packet has a transmission source MAC address of ms. In addition, this packet is received by the port pa of the switch 20-1. In this case, the path table of the switch 20-1 holds a relay rule of “the transmission source MAC address is ms, and the packet received by the port pa is transmitted from the port pb”. Thus, this packet is transmitted to the switch 20-2.

The switch 20-2 having received this packet tries to perform a relay process of this packet. However, since the current path setting is a setting shown in the virtual path table set 80-3, the virtual path table of the switch 20-2 does not have a relay rule. Then, the switch 20-2 transmits a control request to the control device 30. However, the control request transmitted from the switch 20-2 does not satisfy the execution condition 50-2. Thus, the control process of the control device 30 is not performed, and the virtual path table set is not updated. Therefore, even when the control request is transmitted, the switch 20-2 is not able to acquire a relay rule for the received packet, and is not able to relay this packet. Therefore, this packet is undeliverable. In this manner, in Case 2, when the virtual path table set is set to be in the state of 80-3, the path setting is determined to be invalid.

As described above, although the exemplary embodiments of the present invention have been set forth with reference to the accompanying drawings, these exemplary embodiments are merely illustrative of the present invention, and a combination of the above exemplary embodiments and various configurations other than those in the above-mentioned exemplary embodiments can also be adopted.

This application claims priority from Japanese Patent Application No. 2013-094296 filed on Apr. 26, 2013, the content of which is incorporated herein by reference in its entirety.

1. A path setting verification device verifying a path setting of a network system including a host, a switch, and a control device,
wherein the host is connected to at least one of the switches, and transmits a packet to the connected switch,
wherein the switch is connected to the control device, and the host or the other switch,
wherein the switch holds a path table indicating a relay rule for relaying the received packet,
wherein the switch performs a relay process of transmitting to the control device a control request including a header of the packet when the relay rule regarding the received packet is not included in the path table, and
wherein the control device performs a control process of executing an event handler corresponding to an execution condition based on path setting information indicating the event handler and the execution condition in association with each other, when information indicated by the received control request meets the execution condition, the execution condition being a condition in which an event handler is executed,
the path setting verification device comprising:
a topology information acquisition unit acquiring topology information indicating a connection relationship between the host and the switch;
a path setting information acquisition unit acquiring the path setting information;
a test header generation unit generating a test header so that the test header satisfies the execution condition, using the execution condition including a condition relating to the header of the packet among the execution condition indicated in the path setting information;
wherein the topology information further indicates a connection relationship between the switches when the switches are connected to each other.

2. The path setting verification device according to claim 14, wherein when the virtual path table set is updated, the path setting verification unit verifies a validity of a path setting represented by the virtual path table set after the update.

3. The path setting verification device according to claim 14, further comprising a virtual path table history storage unit that stores a history of the virtual path table sets,
wherein after a simulation is terminated with respect to each of a plurality of the permutations included in the test data, the path setting verification unit verifies a validity of a path setting represented by each of the virtual path table sets stored in the virtual path table history storage unit.

4. The path setting verification device according to claim 14, further comprising:
a virtual path table history storage unit storing the history of the virtual path table sets in association with the permutation to be simulated when each virtual path table set is generated;
a virtual path table set input unit accepting an input of the virtual path table set; and
a test packet sequence extraction unit extracting the permutation, corresponding to the virtual path table set being input to the virtual path table set input unit from the virtual path table history storage unit.

5. A control method executed by a computer which verifies a path setting of a network system including a host, a plurality of switches, and a control device,
wherein the host is connected to at least one of the switches, and transmits a packet to the connected switch,
wherein the switch is connected to the control device, and the host or the other switch,
wherein the switch holds a path table indicating a relay rule for relaying the received packet,
wherein the switch performs a relay process of transmitting to the control device a control request including a header of the packet, on the control device when the relay rule regarding the received packet is not included in the path table, and
wherein the control device performs a control process of executing an event handler corresponding to an execution condition based on path setting information indicating the event handler and the execution condition in association with each other, when information indicated by the received control request meets the execution condition, the execution condition being a condition in which an event handler is executed,
the control method comprising:
a topology information acquisition step of acquiring topology information indicating a connection relationship between the host and the switch and a connection relationship between the switches;
a path setting information acquisition step of acquiring the path setting information;
a test header generation step of generating a test header so that the test header satisfies the execution condition, using the execution condition including a condition relating to the header of the packet among the execution condition indicated in the path setting information
wherein the topology information further indicates a connection relationship between the switches when the switches are connected to each other.

6. The control method according to claim 16, wherein when the virtual path table set is updated, the path setting verification step includes a step of verifying a validity of a path setting represented by the virtual path table set after the update.

7. The control method according to claim 16, wherein the computer includes a virtual path table history storage storing a history of the virtual path table sets, and
after a simulation is terminated with respect to each of a plurality of the permutations included in the test data, the path setting verification step includes a step of verifying a validity of a path setting represented by each of the virtual path table sets stored in the virtual path table history storage unit.

8. The control method according to claim 16, wherein the computer includes a virtual path table history storage unit storing the history of the virtual path table sets in association with the permutation to be simulated when each virtual path table set is generated, and
the control method further comprises:
a virtual path table set input step of accepting an input of the virtual path table set; and
a test packet sequence extraction step of extracting the permutation, corresponding to the virtual path table set being input in the virtual path table set input step from the virtual path table history storage unit.

9. A non-transitory computer-readable storage medium storing a program causing a computer to have a function of verifying a path setting of a network system including a host, a plurality of switches, and a control device,
wherein the host is connected to at least one of the switches, and transmits a packet to the connected switch,
wherein the switch is connected to the control device, and the host or the other switch,
wherein the switch holds a path table indicating a relay rule for relaying the received packet,
wherein the switch performs a relay process of transmitting to the control device a control request including a header of the packet, on the control device when the relay rule regarding the received packet is not included in the path table, and
wherein the control device performs a control process of executing an event handler corresponding to an execution condition based on path setting information indicating the event handler and the execution condition in association with each other, when information indicated by the received control request meets the execution condition, the execution condition being a condition in which an event handler is executed,
the program causing the computer to have:
a topology information acquisition function of acquiring topology information indicating a connection relationship between the host and the switch and a connection relationship between the switches;
a path setting information acquisition function of acquiring the path setting information;
a test header generation function of generating a test header so that the test header satisfies the execution condition, using the execution condition including a condition relating to the header of the packet among the execution condition indicated in the path setting information
wherein the topology information further indicates a connection relationship between the switches when the switches are connected to each other.

10. The storage medium according to claim 18, wherein when the virtual path table set is updated, the path setting verification function includes a function of verifying a validity of a path setting represented by the virtual path table set after the update.

11. The storage medium according to claim 18, wherein the computer includes a virtual path table history storage unit storing a history of the virtual path table sets, and
after a simulation is terminated with respect to each of a plurality of permutations included in the test data, the path setting verification function includes a function of verifying a validity of a path setting which is represented by each of the virtual path table sets stored in the virtual path table history storage unit.

12. The storage medium according to claim 18, wherein the computer includes a virtual path table history storage unit storing the history of the virtual path table sets in association with the permutation to be simulated when each virtual path table set is generated,
the program causes the computer to have:
a virtual path table set input function of accepting an input of the virtual path table set; and
a test packet sequence extraction function of extracting the permutation, corresponding to the virtual path table set being input in the virtual path table set function from the virtual path table history storage unit.

13. The path setting verification device according to claim 1, further comprising a test data generation unit generating a test packet set, which is a direct-product set between a set of the hosts and a set of the test headers, and generating test data, which is a set of all permutations capable of being generated by ranking all elements included in the test packet set.

14. The path setting verification device according to claim 13, further comprising:
a virtual path table storage unit storing a virtual path table set, which is a set of virtual path tables obtained by simulating each path table held by a plurality of the switches;
a switch simulation unit sequentially extracting the permutations from the test data, initializing all the virtual path tables when extracting each of the permutations, sequentially extracting the elements from the extracted permutations, and simulating the relay process performed by the switch connected to the host indicated by the extracted elements, the relay process being for the packet having the test header indicated by the elements;
a control device simulation unit simulating the control process performed by the control device on the control request, using the path setting information, when the control request is transmitted in the simulated relay process; and
a path setting verification unit verifying a validity of a path setting represented by the virtual path table set, using the topology information and the virtual path table set,
wherein when a packet is transmitted to another switch by the simulated relay process or the control process, the switch simulation unit recursively simulates the relay process performed by the switch receiving the packet.

15. The control method according to claim 5, further comprising a test data generation step of generating a test packet set, which is a direct-product set between a set of the hosts and a set of the test headers, and generating test data, which is a set of all permutations capable of being generated by ranking all elements included in the test packet set.

16. The control method according to claim 15,
wherein the computer includes a virtual path table storage unit storing a virtual path table set which is a set of virtual path tables obtained by simulating each path table held by the plurality of switches,
the control method further comprising:
a switch simulation step of sequentially extracting the permutations from the test data, initializing all the virtual path tables when extracting each of the permutations, sequentially extracting the elements from the extracted permutations, and simulating the relay process performed by the switch connected to the host indicated by the extracted elements, the relay process being for the packet having the test header indicated by the elements;
a control device simulation step of simulating the control process performed by the control device on the control request, using the path setting information, when the control request is transmitted in the simulated relay process; and
a path setting verification step of verifying a validity of a path setting represented by the virtual path table set, using the topology information and the virtual path table set,
wherein when a packet is transmitted to another switch by the simulated relay process or the control process, the switch simulation step includes a step of recursively simulating the relay process performed by the switch receiving the packet.

17. The storage medium according to claim 9, the program further causing the computer to have a test data generation function of generating a test packet set, which is a direct-product set between a set of the hosts and a set of the test headers, and generating test data, which is a set of all permutations capable of being generated by ranking all elements included in the test packet set.

18. The storage medium according to claim 9,
wherein the computer includes a virtual path table storage unit storing a virtual path table set which is a set of virtual path tables obtained by simulating each path table held by the plurality of switches,
the program further causing the computer to have:
a switch simulation function of sequentially extracting the permutations from the test data, initializing all the virtual path tables when extracting each of the permutations, sequentially extracting the elements from the extracted permutations, and simulating the relay process performed by the switch connected to the host indicated by the extracted elements, the relay process being for the packet having the test header indicated by the elements;
a control device simulation function of simulating the control process performed by the control device on the control request, using the path setting information, when the control request is transmitted in the simulated relay process; and
a path setting verification function of verifying a validity of a path setting represented by the virtual path table set, using the topology information and the virtual path table set
wherein when a packet is transmitted to another switch by the simulated relay process or the control process, the switch simulation function includes a function of recursively simulating the relay process performed by the switch receiving the packet.
